(19) United States
(12) Patent Application Publication
(10) Pub. No.: US 2006/0048173 A1
(43) Pub. Date: Mar. 2, 2006

(54) Optical disc loading apparatus for an optical disc drive

(75) Inventors: Hwan-seung Lee, Yongin-si (KR); Jung-jae Lee, Yongin-si (KR); Young-yun Seol, Seoul (KR); Yong-ju Chi, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/192,144

(22) Filed: Jul. 29, 2005

(30) Foreign Application Priority Data
Aug. 11, 2004 (KR) 2004-63219

(51) Int. Cl. G11B 7/09

(52) U.S. Cl. 720/658

(57) ABSTRACT

A disc loading apparatus for a disc drive, capable of selectively loading discs in different sizes includes a main chassis for mounting a transfer roller for moving the disc, a power transmission unit having a driving motor to transmit power to the transfer roller, a slider transmitted with the power from the power transmission unit and moving in directions for loading and unloading the disc being inserted, a disc guide lever pushed by the disc being inserted, thereby guiding the disc, a pushing lever rotatably mounted to the main chassis to connect the slider to the power transmission unit in association with the disc guide lever, and a locking/releasing unit for selectively locking and separating the disc guide lever with respect to the disc.

### CROSS-REFERENCE TO RELATED APPLICATIONS

This application claims the benefit of Korean Patent Application No. 2004-63219, filed Aug. 11, 2004, in the Korean Intellectual Property Office, the disclosure of which is incorporated herein by reference.

### BACKGROUND OF THE INVENTION

1. Field of the Invention

The present invention relates to a disc loading apparatus for a disc drive. More particularly, the present invention relates to a disc loading apparatus for a disc drive, which selectively loads discs of different sizes.

2. Description of the Related Art

Generally, disc drives record and reproduce information with respect to discs such as a compact disc (CD), a compact disc read-only-memory (CD-ROM), digital video disc (DVD) and a DVD-ROM. To this end, the disc drive comprises a loading apparatus for mounting the disc to a position for recordation or reproduction. The disc inserted from a front of the disc drive is loaded onto a turn table by the loading apparatus and rotatably clamped by a chucking unit. While the disc is rotating on the turn table, an optical pickup moves in a radial direction of the disc to record or reproduce information with respect to the disc.

Recently, a disc loading apparatus without a tray is widely used to reduce a size thereof and save a space. Additionally, a loading apparatus has been disclosed in Korean Patent No. 10-0433415 filed by the present applicant, which is able to selectively load discs in different sizes, for example, 80 mm and 120 mm.

However, the above-structured conventional loading apparatus for a disc drive needs to be equipped with dedicated component parts for independently loading the discs of different sizes and a dedicated sub chassis as well as a main chassis. Since this interferes with miniaturization of the loading apparatus and economy in manufacturing expenditures, researches for simplifying the structure are underway to save cost and minimize the size.

### SUMMARY OF THE INVENTION

Accordingly, it is an aspect of the present invention to solve at least the above problems and/or disadvantages and to provide at least the advantages described below. Another aspect of the present invention is to provide a disc loading apparatus for a disc drive, which provides an improvement by having a simple structure with fewer component parts.

The foregoing and/or other aspects of the present invention are achieved by providing a disc loading apparatus for a disc drive, capable of selectively loading discs of different sizes including a main chassis for mounting a transfer roller for moving the disc, a power transmission unit having a driving motor to transmit power to the transfer roller, a slider transmitted with the power from the power transmission unit and moving in directions for loading and unloading the disc being inserted, a disc guide lever pushed by the disc being inserted, thereby guiding the disc, a pushing lever connecting the slider to the power transmission unit in association with the disc guide lever, and a locking/releasing unit for selectively locking and separating the disc guide lever with respect to the disc. According to the above, a number of parts and manufacturing cost is saved by loading the first and the second discs with the same part.

The locking/releasing unit includes a gear cam rotated by a reciprocal movement of the slider in connection with the slider a locking lever associated with the disc guide lever and the gear cam so as to selectively lock and release the disc guide lever and a releasing lever rotatably associated with the gear cam so as to separate the disc guide lever from the inserted disc.

The disc guide lever includes at least one disc guide projection for guiding the disc to be in contact with the disc guide projection, and the disc guide lever moves among an initial position where the disc guide projection has not yet been in contact with the disc, an intermediate position where the disc guide projection pushes the disc to a chucking position and a separate position where the disc guide lever is separated from the disc being in the chucking position by a predetermined distance.

According to an embodiment of the present invention, the disc guide lever includes a position controlling groove, and the locking lever comprises a position controlling projection for insertion into the position controlling groove, such that the locking lever locks the disc guide lever. The position controlling groove includes first and second position controlling grooves for the position controlling projection to be selectively inserted therein, depending on the size of the disc. The slider includes a cam recess part, and the gear cam includes at least one cam projection part for insertion into the cam recess part of the slider, a gear cam guide slot including a predetermined path therein, and an outer projection part formed at an outside thereof. The locking lever further includes a locking projection pushed by the outer projection part by the rotation of the gear cam, and accordingly, the locking lever is rotated so that the position controlling projection is separated from the position controlling groove of the disc guide lever. The locking lever is elastically biased by the elastic member which is connected to the main chassis.

The disc guide lever includes a cam slot formed in a loading direction of the disc, and the pushing lever includes a stopper boss being inserted in the cam slot and moving along the cam slot. The cam slot includes first and second slots for receiving the stopper boss, selectively, according to a size of the disc.

The pushing lever is elastically biased by an elastic member which is connected to the main chassis. The disc guide lever includes a releasing groove and the releasing lever includes a releasing projection for insertion in the releasing groove, such that the releasing lever moves the disc guide lever from the chucking position to a separate position.

The slider includes a cam recess part, and the gear cam includes at least one cam projection part for insertion into the cam recess part of the slider, a gear cam guide slot including a predetermined path therein, and an outer projection part formed at an outside thereof.

The releasing lever further includes a guide pin moving along the path of the guide slot by rotation of the gear cam, and the releasing lever is rotated by the movement of the guide pin so that the releasing projection is inserted in the releasing groove of the disc guide lever. The disc loading apparatus further includes a door unit for driving the driving motor in contact with a starting switch when the first or second disc is inserted.

The door unit includes first and second door levers interconnected by the elastic member, the first and the second door levers respectively including first and second door projections for guiding the insertion of the disc. The disc loading apparatus further includes a double insertion prevention lever rotatably mounted to the main chassis to prevent insertion of another disc when one disc is in operation.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a plan view illustration of a disc loading apparatus for a disc drive according to an embodiment of the present invention;

FIG. 2 is a side view illustration of FIG. 1;

FIGS. 3 and 4 are views illustrating an operation for loading a 80 mm disc to the disc drive of FIG. 1;

FIGS. 5 and 6 are views for illustrating an operation for loading a 120 mm disc to the disc drive of FIG. 1;

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

Hereinafter, an embodiment of the present invention will be described in detail with reference to the accompanying drawing figures.

A first disc 1 is a general 80 mm disc, and a second disc 2 is a 120 mm disc. A disc loading apparatus according to an embodiment of the present invention is applied for a slot-in type disc drive which is able to compatibly load discs in different sizes without a disc tray.

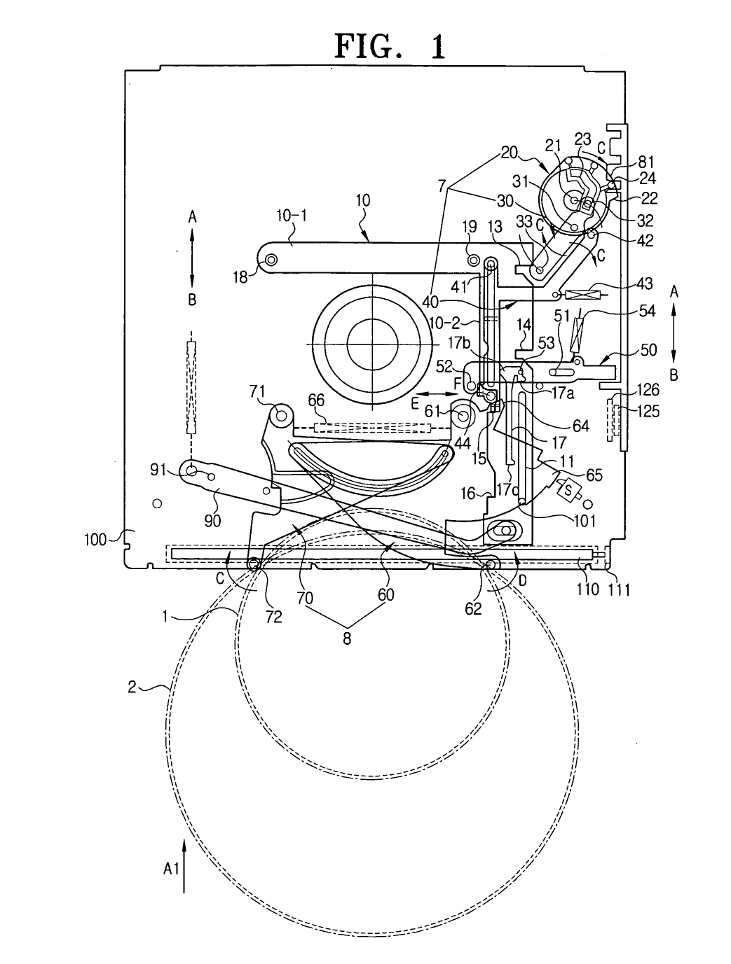

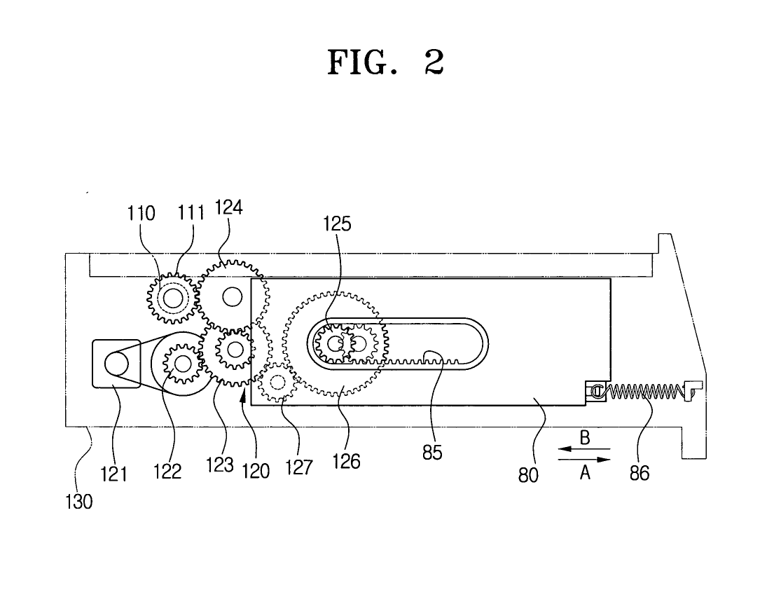

In FIGS. 1 and 2, the disc loading apparatus for a disc drive, according to an embodiment of the present invention, comprises a main chassis 100 having a transfer roller 110, a power transmission unit 120, a slider 80, a disc guide lever 10, a pushing lever 50, a locking/releasing unit 7, a door unit 8 and a double insertion prevention lever 90.

The transfer roller 110 is rotated by power transmitted from the power transmission unit 120, thereby transferring inward a disc inserted from a front of the disc drive, and more specifically, from a lower part of the main chassis 100, and also discharging outward a disc in the disc drive. The transfer roller 110 is supported by a hinge unit (not shown) with both ends thereof. The hinge unit (not shown) is pivotably mounted on the main chassis, and as the hinge unit pivots in association with the slider 80, the transfer roller 110 is brought into contact with or distanced away from the disc being inserted or discharged.

The main chassis 100 is mounted at an upper part of a housing 130 mounting an optical pickup (not shown). The main chassis 100 has a chucking device (not shown) for chucking on the turn table (not shown) the discs 1 and 2 that are transferred to a chucking position.

The power transmission unit 120 comprises a driving motor 121 mounted in the housing 130, a plurality of connection gears 122, 123 and 124 for transmitting the power of the driving motor 121 to a slavery gear 111 connected to the transfer roller 110, a driving gear 125 selectively connected to a rack gear 85 provided to the slider 80, and a main gear 126 connected to the driving gear 125. A simple connection gear 127 interconnects the main gear 126 and the connection gear 123. The driving motor 121 bidirectionally rotates to selectively rotate the transfer roller 110 bidirectionally. Also, the driving motor 121 moves the slider 80 forward and backward with respect to a loading direction of the disc.

The slider 80 connected to the main chassis 100 reciprocates in directions for loading and unloading the inserted discs 1 and 2. The slider 80 comprises the rack gear 85 having a predetermined length. The rack gear 85 is initially distanced from the driving gear 125 until the discs 1 and 2 are loaded to the chucking position. The slider 80 is elastically biased by a spring 86 in ‘A’ direction. When the first and the second discs 1 and 2 are loaded, the slider 80 is pushed by the pushing lever 50, thereby being connected to the driving gear 125.

When the first and the second discs 1 and 2 are inserted into the housing 130 by the transfer roller 110, the disc guide lever 10 guides the inserted discs 1 and 2 to the chucking position, that is, an intermediate position. The disc guide lever 10 comprises disc guide projections 18 and 19, first and second position controlling grooves 15 and 16, a cam slot 17, first and second releasing grooves 13 and 14, and a disc guide lever guide slot 11.

As illustrated in FIG. 1, the pair of disc guide projections 18 and 19 are formed on opposite sides of an upper end 10-1 of the disc guide lever 10. Therefore, the discs 1 and 2 that are transferred by the transfer roller 110 are located in the chucking position, and are contacted with the disc guide projections 18 and 19. The first and the second position controlling grooves 15 and 16 are formed on one side of a vertical part 10-2 of the disc guide lever at a predetermined distance from each other, while the first and the second releasing grooves 13 and 14 are formed on the other side at a predetermined distance from each other.

The cam slot 17 and the disc guide lever guide slot 11 are formed in the center of the vertical part 10-2. The cam slot 17 is formed in a length direction of the disc guide lever 10 and comprises a first slot 17a formed at one end thereof, a second slot 17c formed at the other end, and a third slot 17b formed on a moving path of the first and the second slot 17a and 17c. The disc guide lever guide slot 11 is formed at one side of the cam slot 17. A disc guide lever guide projection 101 formed on the main chassis 100 is slidably received in the disc guide lever guide slot 11.

The pushing lever 50 rotates with respect to a pushing lever rotary shaft 51 by a predetermined angle on the main chassis 100 and comprises a stopper projection 52, a stopper boss 53 and a first elastic member 54. In association with a movement of the disc guide lever 10, the pushing lever 50 moves the slider 80 to connect the slider 80 with the power transmission unit 120.

The stopper boss 53 is formed in the center of the pushing lever 50 and is inserted in the cam slot 17 of the disc guide lever 10. The stopper projection 52 is provided at one end of the pushing lever 50 for association with a position controlling projection 44 of a locking lever 40. The first elastic member 54 interconnects the pushing lever 50 and the main chassis 100, and returns the pushing lever 50 pivoted by the disc guide lever 10 to an initial position.

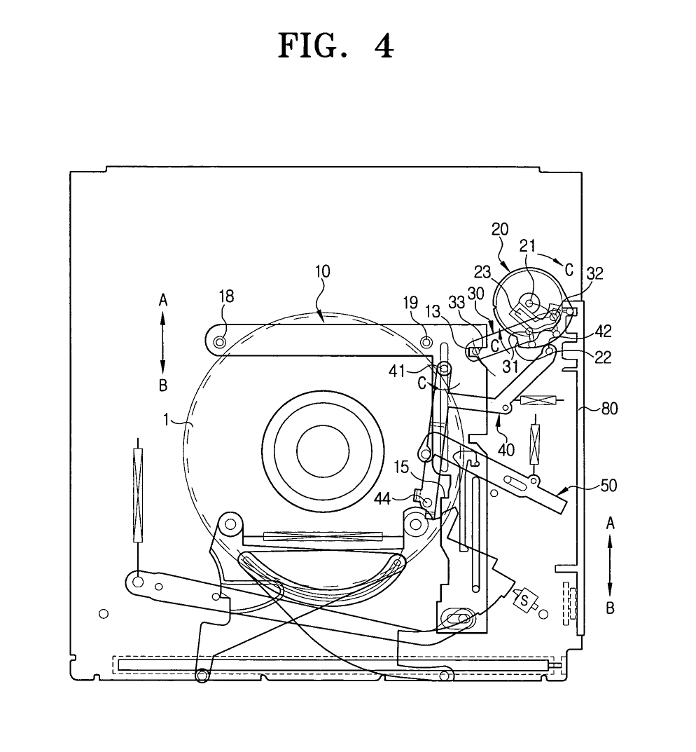

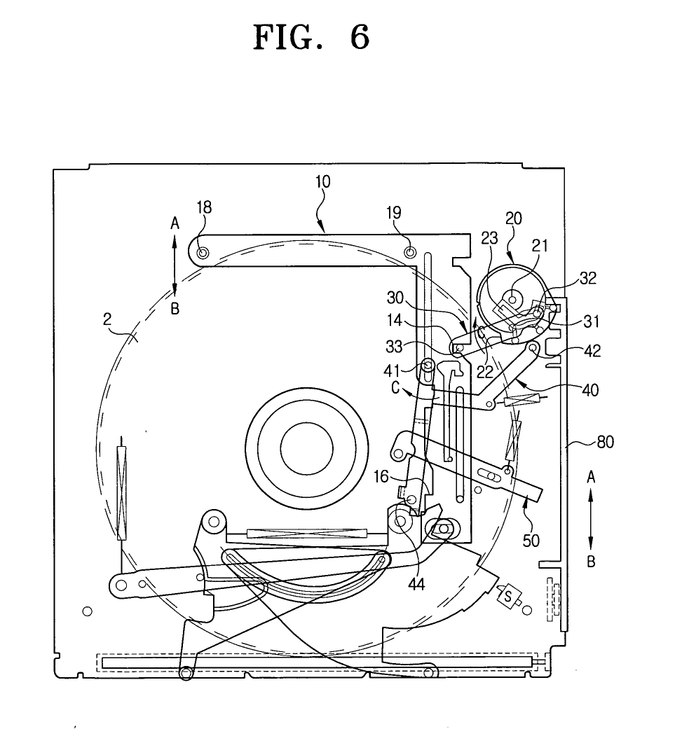

A locking/releasing unit 7 comprises a gear cam 20, the locking lever 40 and a releasing lever 30. The locking/releasing unit 7 operates in association with the guide lever 10 and the slider 80 to selectively lock and unlock the disc guide lever 10 and to distance the disc guide lever 10 from the disc 1 or 2 located in the chucking position to a separate position (FIGS. 4 and 6).

The gear cam 20 rotates with respect to a gear cam rotary shaft 21 by a predetermined angle on the main chassis and comprises an outer projection part 22, a gear cam guide slot 23 and a plurality of cam projection parts 24. The plurality of cam projection parts 24 are inserted in cam recess parts 81 of the slider 80 and moves in association with the slider 80 moving in the ‘B’ direction, thereby rotating the gear cam 20 in the ‘C’ direction. The outer projection part 22 pushes the locking projection 42 in contact with the locking projection 42 of the locking lever 40 when the gear cam 20 rotates, and accordingly, the locking lever 50 rotates with respect to a locking lever rotary shaft 41 in the ‘C’ direction. When the gear cam 20 rotates, the gear cam guide slot 23 guides a movement of a guide pin 32 of the releasing lever 30, being inserted in the gear cam guide slot 23, so that the releasing lever 30 rotates with respect to the releasing lever 30 in the ‘C’ direction.

The locking lever 40 rotates by a predetermined angle with respect to the locking lever rotary shaft 41 on the main chassis 100 and comprises the locking projection 42, a second elastic member 43 and the position controlling projection 44. When the gear cam 20 rotates, the locking projection 42 is obstructed by the outer projection part 22 being rotated, and accordingly moved in the ‘C’ direction (FIG. 1) with respect to the locking lever rotary shaft 41. The position controlling projection 44 is inserted in the first position controlling groove 15 when the first disc 1 is used, and it is inserted in the second position controlling grooves 16 when the second disc 2 is used, in order to lock the disc guide projection 10. The second elastic member 43 connecting the locking lever 40 and the main chassis 100 biases the locking lever 40 towards a locking position.

The releasing lever 30 rotates by a predetermined angle with respect to the releasing lever rotary shaft 31 on the main chassis 100, and comprises the guide pin 32 and a releasing projection 33. The releasing lever 30 operates in association with the gear cam 20 to distance the disc guide lever 10, and to release from the chucking position, the first and the second discs 1 and 2.

The guide pin 32 is inserted in the gear cam guide slot 23 of the gear cam 20 for the operation of the releasing lever 30 in association with the rotation of the gear cam 20. Therefore, the releasing lever 30 rotates with respect to the releasing lever rotary shaft 31 in the ‘C’ direction (FIGS. 4 and 6). The releasing projection 33 is inserted in the first releasing groove 13 when the first disc 1 is used, or the releasing projection 33 is inserted in the second releasing groove 14 when the second disc 2 is used.

The door unit 8 drives the driving motor 121 to be in contact with a starting switch S when the discs 1 and 2 are inserted, and comprises a first door lever 60 and a second door lever 70. The first and the second door levers 60 and 70 are mounted on the main chassis 100 to rotate with respect to first and second door lever rotary shafts 61 and 71 thereof by a predetermined angle, and they are elastically biased by connection with a third elastic member 66. The first and the second door levers 60 and 70 respectively comprise first and second door projections 62 and 72. When the disc 1 or 2 is inserted into the housing 130, the first and the second door projections 62 and 72 are biased toward the loading direction when in contact with the disc 1 or 2.

When one of the discs 1 and 2 is in operation in the housing 130, the double insertion prevention lever 90 prevents insertion of another disc. The double insertion prevention lever 90 is mounted on the main chassis 100 and rotates with respect to a double insertion prevention lever rotary shaft 91 by a predetermined angle.

Herein below, the operation of the loading apparatus for the disc drive, according to an embodiment of the present invention, will be described.

First, the operation for loading the first disc 1, which is a 80 mm disc, is as follows.

As shown in FIG. 1, the first disc 1 is inserted into the housing 130 in the ‘A1’ direction, that is, the loading direction. The disc guide lever 10 is in an initial state where it is not obstructed by the first disc 1. The inserted first disc 1 pushes the first and the second door levers 60 and 70 in contact with the first and the second door projections 62 and 72. The first and the second door levers 60 and 70 rotate with respect to the first and the second door lever rotary shafts 61 and 71 in the ‘D’ and ‘C’ directions, respectively, and thereby are distanced from each other. A protruded cam 65 of the first door lever 60 is contacted with the starting switch S, to thereby operate the driving motor 121 (FIG. 2). Accordingly, the transfer roller 110 rotates, and the first disc 1 is drawn into the housing 130 by the transfer roller 110.

The first disc 1 being inserted is brought into contact with both of the disc guide projections 18 and 19 of the disc guide lever 10. By the continuous rotation of the transfer roller 110, the first disc 1 moves the disc guide lever 10 in the ‘A’ direction.

As the disc guide lever 10 is lifted in the ‘A’ direction, the first slot 17a of the cam slot 17 contacts and pushes the stopper boss 53 of the pushing lever 50. Therefore, the pushing lever 50 rotates about the pushing lever rotary shaft 51 in ‘C’ direction, thereby pushing the slider 80 with one end thereof in ‘B’ direction by a predetermined distance.

When the slider 80 is pushed by a predetermined distance, the rack gear 85 comes into connection with the driving gear 125, as shown in FIG. 2. The power of the driving gear 125 is transmitted to the rack gear 85, and therefore, the slider 80 is kept moving in the ‘B’ direction.

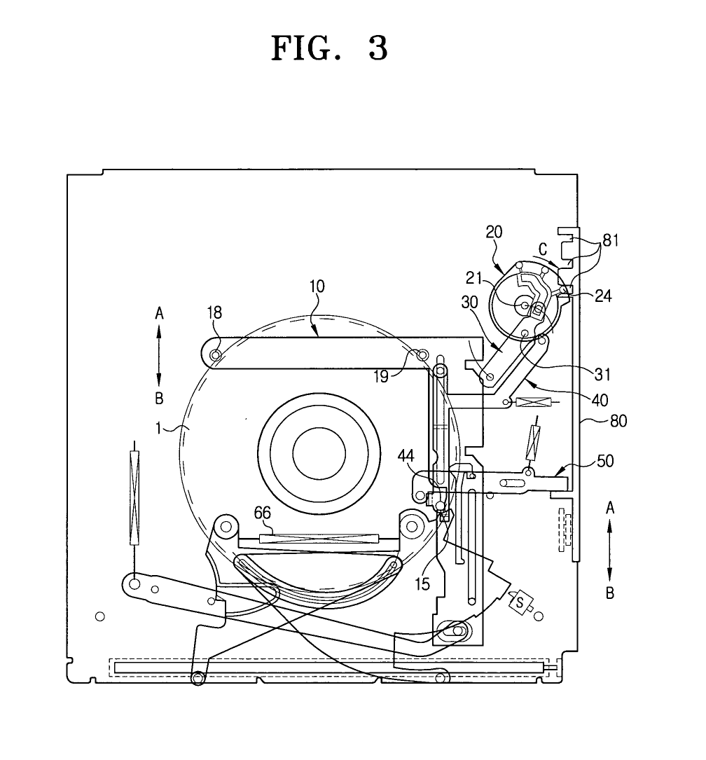

FIG. 3 shows the disc guide lever 10 in the intermediate position, that is, in the chucking position. In FIG. 3, the first disc 1 is lifted in the ‘A’ direction and pushes the disc guide lever 10 that is guided by the disc guide projections 18 and 19 up to the chucking position. The chucking position is controlled in a manner that the first position controlling groove 15 of the disc guide lever 10 is hitched by the position controlling projection 44 of the locking lever 40. More specifically, as the first position controlling groove 15 is hitched by the position controlling projection 44, the disc guide lever 10 cannot move upward in the ‘A’ direction any more. Accordingly, the first disc 1 cannot move up either, and this point is determined to be the chucking position. When the first disc 1 reaches the chucking position, a dedicated chucking device performs the chucking operations.

As described above, the slider 80 keeps moving in the ‘B’ direction even after the chucking operation. As a result, the cam projection part 24 that is inserted in the cam recess part 81 of the slider 80 rotates in the ‘C’ direction, thereby rotating the gear cam 20 with respect to the gear cam rotary shaft 21 in the ‘C’ direction.

FIG. 4 shows the disc guide lever 10 in the separate position. In FIG. 4, as the gear cam 20 rotates, the outer projection part 22 of the gear cam 20 pushes the locking projection 42 of the locking lever 40, thereby rotating the locking lever 40 with respect to the locking lever rotary shaft 41 in the ‘C’ direction. Consequently, the position controlling projection 44 is separated from the first position controlling groove 15 of the disc guide lever 10.

Also, as the gear cam 20 rotates, the guide pin 32 of the releasing lever 30 that is inserted in the gear cam guide slot 23 of the gear cam 20 moves along the gear cam guide slot 23. Therefore, the releasing lever 30 is rotated with respect to the releasing lever rotary shaft 31 in the ‘C’ direction. Therefore, the releasing projection 33 of the releasing lever 30 is inserted into the first releasing groove 13 of the disc guide lever 10. When the gear cam 20 makes more rotation in the ‘C’ direction by a predetermined angle, the disc guide lever 10 is lifted more in the ‘A’ direction, thereby being distanced from the first disc 1 to the separate position.

When the disc guide projections 18 and 19 of the disc guide lever 10 are distanced from the first disc 1, the first disc 1 becomes rotatable on the turn table (not shown), and is chucked by the dedicated chucking device (not shown). Thus, when the loading of the first disc 1 is completed, the first disc 1 rotates on the turn table to record or reproduce information by the optical pickup.

For unloading of the first disc 1 after which the loading is completed, the driving motor 121 (FIG. 2) is counter-rotated to return the slider 80 in the ‘A’ direction. By performing the other processes in reverse order, the first disc 1 is discharged to the outside of the housing 130.

Hereinbelow, a description will be made with regard to the operation for loading the second disc 2, that is, a 120 mm disc which is larger than the first disc 1.

In the operation for loading the second disc 2, a main difference from the loading operation for the first disc 1 is that the disc guide lever 10 for guiding the second disc 2 to the chucking position is lifted further up in the ‘A’ direction because the diameter of the second disc 2 is greater than that of the first disc 1.

More specifically, the second disc 2 is inserted into the housing 130 in the ‘A1’ direction. That is, the loading direction with the disc guide lever 10 in the initial state as shown in FIG. 1. The inserted second disc 2 pushes the first and the second door levers 60 and 70, and is contacted with the first and the second door projections 62 and 72 of the first and the second door levers 60 and 70. The first and the second door levers 60 and 70 are rotated with respect to the first and the second door lever rotary shafts 61 and 71 in the ‘C’ and D’ directions, respectively, thereby being distanced from each other. The protruded cam 65 of the first door lever 60 is contacted with the starting switch S in order to operate the driving motor 121 (FIG. 2). Accordingly, the transfer roller 110 rotates, and the second disc 2 is drawn into the housing 130 by the transfer roller 110.

The second disc 2 after being inserted is brought into contact with the disc guide projections 18 and 19 of the disc guide lever 10. By continuous rotation of the transfer roller 110, the second disc 2 moves the disc guide lever 10 in the ‘A’ direction.

When the second disc 2 is inserted, the first door lever 60 is rotated with respect to the first door lever rotary shaft 61 in the ‘D’ direction by a greater degree compared to when the first disc 1 is inserted, since the diameter of the second disc 2 larger than that of the first disc 1. The position controlling projection 44 of the locking lever 40 in association with the pushing projection 64 of the first door lever 60 pushes the stopper projection 52 of the pushing lever 50 in ‘E’ direction. Accordingly, the stopper boss 53 of the pushing lever 50 comes close to the third slot 17b of the cam slot 17, and as the disc guide lever 10 moves in the ‘A’ direction, the stopper boss 53 is hitched by the second slot 17c of the cam slot 17. As the disc guide lever 10 is lifted in the ‘A’ direction, the second slot 17c of the cam slot 17 pushes the stopper boss 53 of the pushing lever 50. Therefore, the pushing lever 50 is rotated with respect to the pushing lever rotary shaft 51 in the ‘C’ direction, thereby pushing the slider 80 with the one end thereof in the ‘b’ direction by a predetermined distance.

When the slider 80 is pushed to a predetermined distance, the rack gear 85 comes into connection with the driving gear 125, as shown in FIG. 2. The power of the driving gear 125 is transmitted to the rack gear 85, and therefore, the slider 80 is kept moving in the ‘B’ direction.

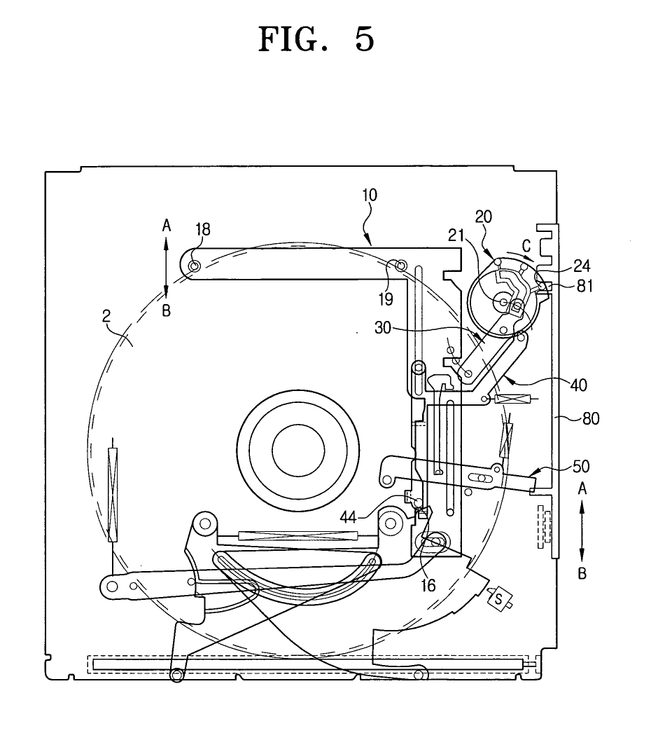

FIG. 5 shows the disc guide lever 10 in the intermediate position. In FIG. 5, the second disc 2 lifts in the ‘A’ direction and pushes the disc guide lever 10, and is guided by the disc guide projections 18 and 19 up to the chucking position. The chucking position is fixed in a manner that the second position controlling groove 16 of the disc guide lever 10 is hitched by the position controlling projection 44 of the locking lever 40. More specifically, as the second position controlling groove 16 is hitched by the position controlling projection 44, the disc guide lever 10 cannot move upward in the ‘A’ direction any more. Accordingly, the second disc 2 cannot move up either, and this point is determined to be the chucking position. When the second disc 2 reaches the chucking position, a dedicated chucking device performs the chucking operations.

As described above, the slider 80 keeps moving in the ‘B’ direction even after the chucking operation. As a result, the cam projection part 24 inserted in the cam recess parts 81 of the slider 80 rotates in the ‘C’ direction, thereby rotating the gear cam 20 with respect to the gear cam rotary shaft 21 in the ‘C’ direction.

FIG. 6 illustrates the disc guide lever 10 in a final position, that is, the separate position. In FIG. 6, as the gear cam 20 rotates, the outer projection part 22 of the gear cam 20 pushes the locking projection 42 of the locking lever 40, thereby rotating the locking lever 40 with respect to the locking lever rotary shaft 41 in the ‘C’ direction. Consequently, the position controlling projection 44 is separated from the second position controlling groove 16 of the disc guide lever 10.

Also, as the gear cam 20 rotates, the guide pin 32 of the releasing lever 30 that is inserted in the gear cam guide slot 23 of the gear cam 20 moves along the gear cam guide slot 23. Therefore, the releasing lever 30 is rotated with respect to the releasing lever rotary shaft 31 in the ‘C’ direction. Thus, the releasing projection 33 of the releasing lever 30 is inserted into the second releasing groove 14 of the disc guide lever 10. If the gear cam 20 makes more rotation in the ‘C’ direction by a predetermined angle, the disc guide lever 10 is lifted more in the ‘A’ direction, thereby being distanced from the second disc 2 to the separate position.

When the disc guide projections 18 and 19 of the disc guide lever 10 are distanced from the second disc 2, the second disc 2 becomes rotatable on the turn table (not shown), after being chucked by the dedicated chucking device (not shown). Thus, loading of the second disc 2 is completed, and the second disc 2 rotates on the turn table to record or reproduce information by the optical pickup.

For unloading of the second disc 2 after the loading is completed, the driving motor 121 (FIG. 2) is counter-rotated to return the slider 80 in ‘A’ direction. By performing the other processes in reverse order, the second disc 2 can be discharged to the outside of the housing 130.

As can be appreciated from the above description, in the disc loading apparatus for a disc drive according to an embodiment of the present invention, the first and the second discs 1 and 2 of different sizes can be loaded to the chucking position using the same component part. Therefore, the number of parts and the manufacturing cost can be reduced.

The assemblability and compactness also improve.

In addition, since the loading and separation of the disc is controlled directly by the disc guide lever 10 which guides the disc by a vertical movement, a plurality of gear members used in the conventional disc loading apparatus can be saved, thereby improving the accuracy of the apparatus.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A disc loading apparatus to load and unload first and second discs of different sizes, where the second disc is larger than the first disc, the disc loading apparatus comprising:
a main chassis to mount a transfer roller to move the disc;
a power transmission unit having a driving motor to transmit power to the transfer roller;
a slider transmitted with the power from the power transmission unit moving in directions to load and unload the disc being inserted;
a disc guide lever pushed by the disc being inserted to guide the disc;
a pushing lever connecting the slider to the power transmission unit in association with the disc guide lever; and
a locking/releasing unit to selectively lock and separate the disc guide lever with respect to the disc.

2. The disc loading apparatus of claim 1, wherein the locking/releasing unit comprises:
a gear cam rotated by a reciprocal movement of the slider in connection with the slider;
a locking lever associated with the disc guide lever and the gear cam so as to selectively lock and release the disc guide lever; and
a releasing lever associated with the gear cam so as to separate the disc guide lever from the inserted disc.

3. The disc loading apparatus of claim 2, wherein the disc guide lever comprises at least one disc guide projection for guiding the disc to be in contact with the disc guide projection, and the disc guide lever moves among an initial position where the disc guide projection has not yet contacted with the disc, an intermediate position where the disc guide projection pushes the disc to a chucking position and a separate position where the disc guide lever is separated from the disc being in the chucking position by a predetermined distance.

4. The disc loading apparatus of claim 3, wherein the intermediate position and the separate position are determined to be different according to a size of the disc being inserted.

5. The disc loading apparatus of claim 4, wherein the disc guide lever comprises a position controlling groove, and the locking lever comprises a position controlling projection to insert into the position controlling groove, such that the locking lever locks the disc guide lever.

6. The disc loading apparatus of claim 5, wherein the position controlling groove comprises first and second position controlling grooves for the position controlling projection to be selectively inserted thereinaccording to a size of the disc.

7. The disc loading apparatus of claim 5, wherein the slider comprises a cam recess part, and the gear cam comprises at least one cam projection part to insert into the cam recess part of the slider, a gear cam guide slot including a predetermined path therein, and an outer projection part formed at an outside thereof.

8. The disc loading apparatus of claim 7, wherein the locking lever further comprises a locking projection pushed by the outer projection part by rotation of the gear cam, and the locking lever is rotated so that the position controlling projection is separated from the position controlling groove of the disc guide lever.

9. The disc loading apparatus of claim 8, wherein the locking lever is elastically biased by the elastic member which is connected to the main chassis.

10. The disc loading apparatus of claim 4, wherein the disc guide lever comprises a cam slot formed in a loading direction of the disc, and
the pushing lever comprises a stopper boss being inserted in the cam slot and moving along the cam slot.

11. The disc loading apparatus of claim 10, wherein the cam slot comprises first and second slots to receive the stopper boss-selectively, according to a size of the disc.

12. The disc loading apparatus of claim 10, wherein the pushing lever is elastically biased by an elastic member which is connected to the main chassis.

13. The disc loading apparatus of claim 4, wherein the disc guide lever comprises a releasing groove and the releasing lever includes a releasing projection to insert in the releasing groove, such that the releasing lever moves the disc guide lever from the chucking position to the separate position.

14. The disc loading apparatus of claim 13, wherein the releasing groove comprises first and second releasing grooves for the releasing projection to be selectively inserted therein according to a size of the disc.

15. The disc loading apparatus of claim 13, wherein the slider comprises a cam recess part, and the gear cam comprises at least one cam projection part to insert into the cam recess part of the slider, a gear cam guide slot including a predetermined path therein, and an outer projection part formed at an outside thereof.

16. The disc loading apparatus of claim 15, wherein the releasing lever further comprises a guide pin moving along the path of the guide slot by rotation of the gear cam, and
the releasing lever is rotated by the movement of the guide pin so that the releasing projection is inserted in the releasing groove of the disc guide lever.

17. The disc loading apparatus of claim 1, further comprising a door unit to drive the driving motor in contact with a starting switch when the first or second disc is inserted.

18. The disc loading apparatus of claim 17, wherein the door unit comprises first and second door levers interconnected by the elastic member, the first and the second door levers respectively comprising first and second door projections to guide insertion of the disc.

19. The disc loading apparatus of claim 1, further comprising a double insertion prevention lever rotatably mounted to the main chassis to prevent insertion of another disc when one disc is in operation.

20. A disc loading method comprising:
mounting a transfer roller to move a disc;
transmitting power through a power transmission unit to the mounted transfer roller;
moving a slider with the transmitted power in directions to load and unload the disc being inserted;
guiding the disc with a disc guide lever;
connecting the slider to the power transmission unit in association with the disc guide lever; and
locking and separating selectively the disc guide lever with respect to the disc.
